(19) United States
(12) Patent Application Publication
(10) Pub. No.: US 2012/0075459 A1
(43) Pub. Date: Mar. 29, 2012

(54) Miniature viewing camera and remote receiver unit

(76) Inventor: Timothy E. Stuehmeyer, Colorado Springs, CO (US)

(21) Appl. No.: 12/924,156

(22) Filed: Sep. 23, 2010

(51) Int. Cl. H04N 7/18

(52) U.S. Cl. 348/82; 348/E07.085

(57) ABSTRACT

A miniature camera and remote receiver unit for viewing, observing and photographing small, confined and hard-to-get at spaces or areas includes a miniature wireless camera pivotally mounted to the end of a rod or wand with the power being provided by a power cord plugged into an outlet or being provided by an optional 9 volt power supply and the camera capable of transmitting images in real time a distance of at least several hundred feet to a remote handheld receiver unit that includes a display screen for viewing the images with the receiver unit being multi-channel to accommodate different data transmitting conditions and the receiver unit can also include an earphone as the receiver unit will include volume control buttons among its control functions.

### FIELD OF THE INVENTION

The present invention pertains to devices and apparatus for viewing in small, confined, and difficult-to-reach spaces, and more particularly pertains to a system that includes a portable viewing camera that has the ability to transmit images to a remote receiver unit.

### BACKGROUND OF THE INVENTION

One of the most frustrating and annoying occurrences is when an individual such as a worker on a job site, a construction, plumbing, electrician, welder, dry waller, etc., a moving company, painters, contractors, engineers must perform work or examine a part or portion of another structure that is behind a larger structure. The larger structure can be anything ranging from appliances, cabinets, storage closets, refrigeration units, shelving, etc., with the gap between such structures and the wall being very narrow and thus hard to get at let alone clearly see behind. In order to see behind such narrow spaces, gaps, crevices, etc., one expedient is to shine a flashlight in the gap, space, crevice to locate an object, search for an object or identify the area or structure to be worked on. With the invention of remote controlled devices this task has been made easier yet there are still problems with viewing, inspecting, working on, etc., elements or features that are located in tight spots, behind or in between structures or in hard to get at places and locations.

For example, the Pyle et al. patent (U.S. Pat. No. 7,068,306 B2) discloses a proxy-based remote control method and system for a digital camera that includes an image capture system, a foreign remote control and a first device.

The Ohta patent (U.S. Pat. No. 7,312,872 B2) discloses a system and method for automated positioning of a camera that includes a remote control configured to generate a spot signal in response to input from a user with the camera further including a positioning subsystem and processing subsystem.

The Marcus patent (U.S. Pat. No. 7,379,664 B2) discloses a remote view and controller for a camera that includes a display screen, a remote from the camera and a processing for receiving an image from the camera.

The Kato patent (U.S. Pat. No. 7,414,649 B2) discloses a camera apparatus controllable by an optical signal and which includes an image pickup device, a camera control method, and a recording medium having the control and a recording medium having the control camera recorded therein.

The Yamaguchi patent (U.S. Pat. No. 7,474,336 B2) discloses a remote control apparatus of digital video camera that is compatible with two types of digital video cameras.

Nonetheless, despite the ingenuity of the above devices, there remains a need for a miniature camera and receiver unit that is able to see inside small or confined spaces.

### SUMMARY OF THE INVENTION

The present invention comprehends a miniature camera and receiver unit that is adaptable for viewing inside and around small, tight, or confined spaces, into crevices, gaps, openings, etc. while being remotely operated. The primary elements or features of the unit include a small camera that is attached to a telescopic wand or is also attachable to a solid object; and the camera is designed to transmit images to a remote receiver. The apparatus includes a power connection to go with the camera and remote receiver unit. The receiver unit may also work with an earpiece headphone as the receiver unit includes volume controls, and the telescopic wand or rod is movable and adjustable as necessary to view the small, tight, confined or narrow spaces, gaps, openings, etc.

Thus, the present invention comprehends a miniature camera and receiver unit that includes the telescoping wand or rod that has several telescoping interfitted segments or members. The wand includes an upper end, and the upper end includes a pivotal or pivoting feature that may comprise a pair of ears, hinges or flanges with a pivot pin extending through the ears, hinges, or flanges. The camera, preferably of the miniature, digital type, is mounted to the pivoting structure for at least a 270-degree angle of rotation as well as pivotal movement in the vertical plane. The camera can be detachable for cleaning and maintenance purposes. The camera includes at least two power supply means: one power supply means can be a power cord of sufficient length to allow for the remote use of the camera and the other power supply means is an optional 9 volt power supply electrically connected to the camera by an electrical cord of sufficient length to allow for the remote use of the camera.

While one of the workers manipulates the wand and the digital camera mounted thereto, another worker or individual standing or positioned remotely from the worker with the wand and camera holds the receiver unit that receives the images transmitted from the digital camera. The receiver unit is preferably a multi-channel receiver, and includes a number of features such as a display screen, volume control, and voice broadcast capabilities. It should be noted that the images sent to the receiver unit are not thermal images but actual images produced and transmitted in real time.

It is an objective of the present invention to provide a miniature viewing camera and receiver unit that accommodates a wide variety of applications and a wide range of uses.

It is another objective of the present invention to provide a miniature viewing camera and receiver unit that assists anyone in seeing behind, under or around small objects, or in tight spaces.

It is still yet another objective of the present invention to provide a miniature viewing camera and receiver unit that can be used in computer repair, vehicle repair, plumbing repair, electrical repair. etc.

It is still yet a further objective of the present invention to provide a miniature viewing camera and receiver unit that includes a telescoping wand or handle that can be moved and adjusted as necessary to view the small or tight spaces.

Still another objective of the present invention to provide a miniature viewing camera and receiver unit that can be used with an earpiece headphone as the receiver unit includes volume controls.

Still yet another objective of the present invention is to provide a miniature viewing camera and receiver unit that can operate on 100-240v and 50/60 Hz frequencies anywhere in the world.

Still yet a further objective of the present invention is to provide a miniature viewing camera and receiver unit wherein the camera can be attached to a various fixtures such as a tripod, a fixed post or a magnetic mount.

A further objective of the present invention is to provide a miniature viewing camera and receiver unit wherein the images that are sent to the hand held can be transmitted over distances ranging from up to several hundred feet.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

FIG. 1 is a top plan view of the miniature viewing camera and receiver unit of the present invention illustrating the use of the apparatus by several individuals in a small and confined area;

FIG. 2 is a perspective view of the miniature viewing camera and receiver unit of the present invention illustrating the various individual components of the device;

FIG. 3 is a perspective view of the miniature viewing camera and receiver unit of the present invention illustrating the various components of the device and the optional earpiece;

FIG. 4 is a perspective of the miniature viewing camera and receiver unit of the present invention illustrating one method of mounting a viewing camera or other optical device to the telescoping wand;

FIG. 5 is a perspective view of the miniature viewing camera and receiver unit of the present invention illustrating the pivotal mounting of the viewing camera to the upper end of the telescoping wand; and

FIG. 6 is a representative schematic or flowchart illustrating the basic image recognition, viewing, transmitting, and processing steps for the apparatus when used in the field.

### DETAILED DESCRIPTION OF THE PREFERRED EMBODIMENT

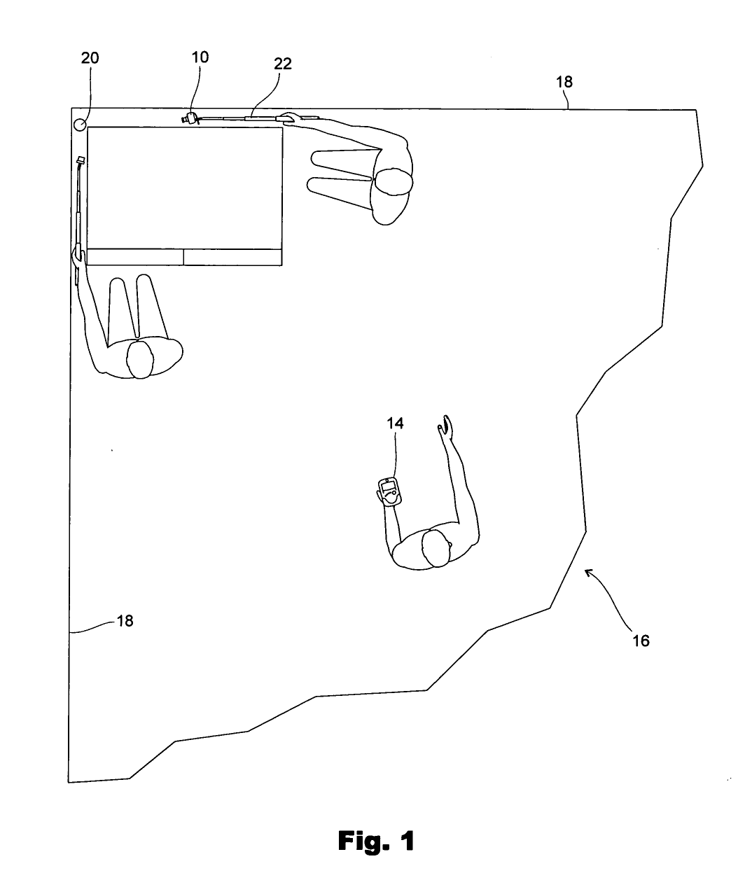

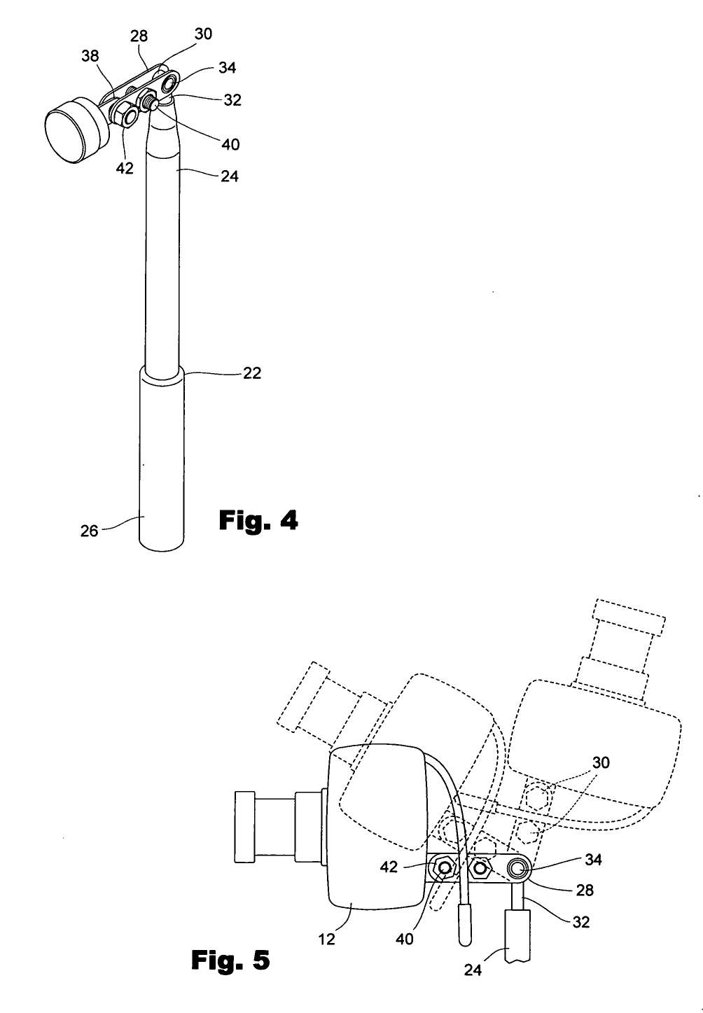

Illustrated in FIGS. 1-6 is a remote visual observation apparatus 10 that includes a miniature camera 12 and remote receiver unit 14 that is designed to photograph objects, scenes, situations, etc. with the miniature camera 12 capable of transmitting images in real time to the remote receiver unit 14 that can be located many feet from the camera 12, including distances of up to at least 200 hundred feet. The camera 12, preferably a digital camera, includes a built-in radio transmitter for conveying the images to a remote site or location. The convenient wireless camera kit accommodates a diverse range of applications and is designed to help anyone—workers on commercial and industrial sites, construction workers, highway workers, day laborers, reclaimers and salvagers, etc., —see behind, under or around small objects or in tight and narrow gaps, crevices, niches, openings, otherwise inaccessible spaces and places, etc. Some of the applications for this apparatus 10 include computer repair, plumbing repair, electrical repair, construction, and search and rescue.

Illustrated in FIG. 1 is a representative environment that the camera 12 and receiver unit 14 may be used; and the environment includes a room 16 having at least two walls 18 and an object 20, such as a shelf, storage cabinet, or machine, pushed up to the corner where the two walls 18 meet thus leaving a very narrow space or gap therebetween. The workers are attempting to visually locate some object behind the shelf, storage cabinet or machine 20 that is hard to get and hard to visually see with the unaided eye. While two workers are maneuvering the miniature camera 12 and receiver unit 14 another worker is holding the receiver unit 14 that is receiving images from the miniature camera 12. The worker holding the receiver unit 14 is representatively shown in proximity with the other workers but in theory could be several hundred feet away.

Thus, as illustrated in FIGS. 1-6, the miniature camera 12 and receiver unit 14 includes a lightweight handheld telescoping or extensible and retractable wand or rod 22. The wand or rod 22 includes an upper end 24 and an opposite lower or handle end 26. The upper end 24 includes a pivoting means such as a hinge member. In the preferred embodiment, the hinge member includes a pair of ears or plates 28 each having at least three spaced through holes 30 and the upper end 24 terminating at a pivot portion 32 having an aperture or through hole through which a pivot pin or locking bolt 34 is inserted. The through holes 30 for each plate 28 are aligned with the through hole on the pivot portion 32 and then the pivot pin 34 is passed through the plates 28 and the pivot portion 32 thereby securing the plates 28 to the pivot portion 32 at the upper end 24 of the wand 22. Because each plate 28 has three through holes 30 the distance the camera 12 projects into the gap, crevice, or narrow space can be adjusted; and thus the pivot portion 32, the pivot pin 34, the plates or flanges 28 provide for the extensible adjustability of the camera 12 relative to the area, place, or object that is being photographed. The miniature camera 12 is attached to the plates 28 by a rearward projecting stem or rod 38 that has an aperture extending therethrough with the rod 38 inserted between the plates 28 so that the aperture aligns with one of the three pairs of plate through holes 30 thereby allowing for the insertion of the pivot pin 34. Locking bolts 40 are inserted through at least two pairs of aligned through holes 30 of the plates to fasten the plates 28 together and then lock nuts 42 are secured to the locking bolts 40 to maintain the bolts 40 in place. Thus, the miniature camera 12 is pivotably or rotatably interconnected to the wand 22 through the plates 28 and the pivot pin 34 that is passed through the aperture of the pivot portion 32 located at the upper end 24 of the wand 22. Generally, either one or two locking bolts 40 are used to secure the stem 38 to the plates 28, and thus to the upper end 24 of the telescoping wand 22. The pivoting means allows the miniature camera 12 to pivot at least up to 270 degrees. It is also possible to use a ball joint pivot means located at the upper end 24 of the wand 22 to provide the camera 12 with maximum range of horizontal and vertical motion.

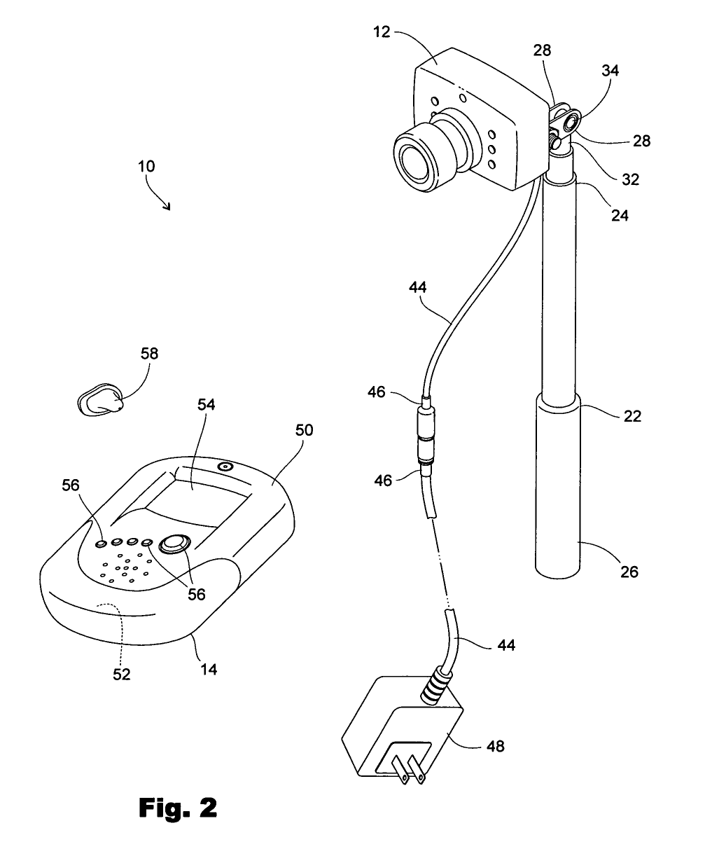

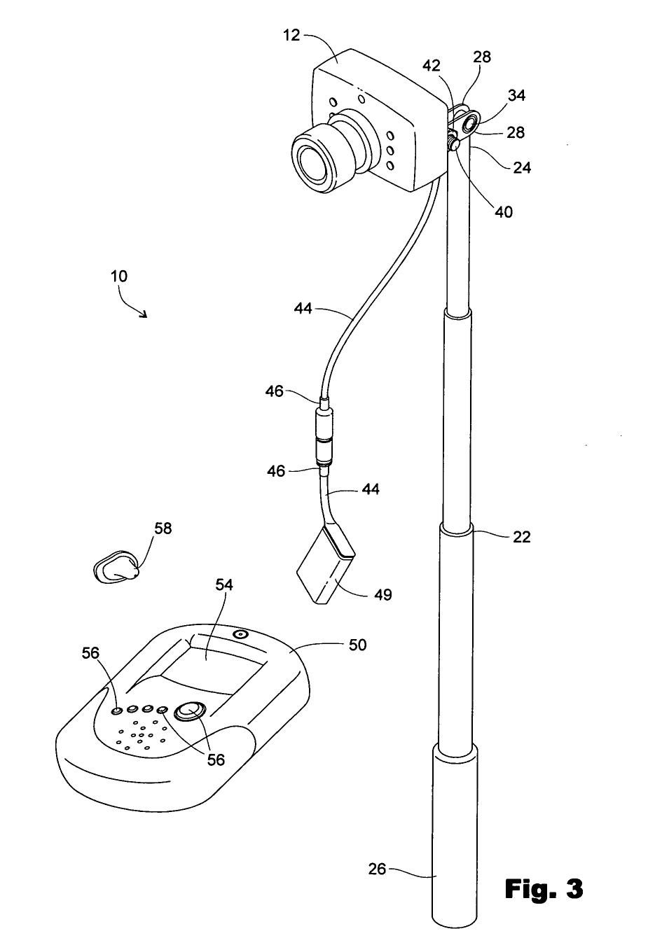

As shown in FIGS. 2 and 3, the camera 12 is preferably a digital camera and includes several power sources. In FIG. 2 the power source is an electric cord 44 that has a connection end or barrel 46 for attachment to the connection barrel 46 of a second power cord 44 with the lengths of one or more power cords 44 being anywhere from 20 to 50 feet or more in length; and the last power cord 44 terminating with a plug 48 for giving the camera 12 the greatest possible flexibility in maneuvering to photograph the particular area, space, niche, object, feature or gap. In addition, an optional power supply can be provided by a 9 volt power supply 49 which is useful if the area to be viewed and inspected remote from a standard wall outlet or receptacle.

Illustrated in FIGS. 1-3 is the lightweight, portable, handheld multi-channel receiver 14 that receives the images in real time transmitted by and from the camera 12. The multi-channel receiver 14 preferably operates on 2.4 GigaHz electrical frequency and can operate on 100-240v and 50/60 Hz frequencies thus is operational anywhere in the world. The multi-channel receiver 14 has a front side 50 and a backside 52, and located on the front side 50 is a display screen 54 and manual function knobs or buttons 56. Also located on the front side 50 is a display screen for displaying the images transmitted by the camera 12. The function buttons 56 include buttons for turning the unit on and off, image resolution buttons, display screen on and off buttons, image scrolling buttons, send, delete, and save buttons, and a volume control button. In addition, an earpiece headphone 58 can be included and thus the miniature camera and receiver unit 10, along with the earpiece 58 can be presented and packaged as a combination wireless camera kit.

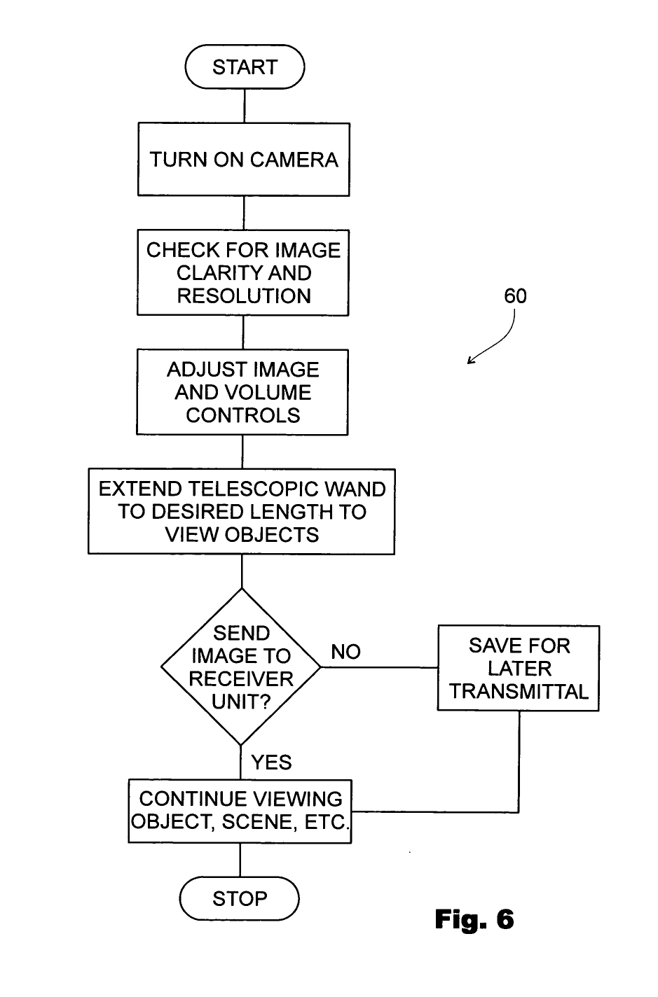

FIG. 6 is a representative schematic or flowchart 60 for the field operation of the unit 10 and is meant as an example only. Thus, with the unit 10 in the field and powered up and ensured with a safe and reliable electrical connection, the individual, user or worker first turns on the camera 12. The individual then checks for image clarity and resolution. Next image and volume controls need to be adjusted. After that the individual would extend the telescopic wand 22 to the desired length to view the object, area, space, scene, etc. Images of the object, area, space, scene, etc. are then produced and the individual can make a number of decisions specifically whether to transmit the image to the multi-channel receiver unit or have the image saved for later viewing and inspection. The individual would then continue viewing

Although the embodiments of the present invention have been described herein with reference to the accompanying drawings, obviously many modifications, alterations, and variations may be made by those skilled in the art without departing from the scope of the invention.

I claim:

1. A remote visual observation and photography apparatus for viewing and photographing objects in difficult to reach, inaccessible narrow and confined spaces and transmitting images to a remote site, comprising:
an elongated telescoping extensible and retractable wand;
the wand including an upper end and a lower handle end and the upper end including a pivoting means;
a miniature camera for photographing and remotely transmitting the images of the difficult-to-reach, inaccessible, narrow and confined spaces with the camera attached to the pivoting means;
a multi-channel receiver unit located at a position remote from the miniature camera with the receiver unit capable of receiving and processing the images transmitted from the miniature camera;
the receiver unit including a plurality of function control buttons and a display screen for displaying the images transmitted from the miniature camera; and
the miniature camera transmitting in real time images of the difficult-to-reach, inaccessible, narrow and confined spaces and objects and features therein to the remotely situated receiver unit.

2. The remote visual photography and observation apparatus of claim 1 wherein the miniature camera and the receiver unit operate on 2.4 Gigahertz electrical frequency and 100-240 volt and 50/60 Hz frequencies.

3. The remote visual photography and observation apparatus of claim 2 further comprising an earpiece headphone that is interactive with the receiver unit.

4. The remote visual photography and observation apparatus of claim 3 wherein the receiver unit can be separated from the miniature camera by a distance of at least several hundred feet.

5. The remote visual photography and observation apparatus of claim 4 wherein one of the function control buttons is for the volume control of the receiver unit.

6. The remote visual photography and observation apparatus of claim 5 wherein the upper end includes a pivot portion and the pivot portion includes an aperture extending therethrough.

7. The remote visual photography and observation apparatus of claim 6 wherein the pivoting means includes a pair of plates with each plate having a plurality of spaced-apart through holes with the through holes of one plate being aligned with the through of the other plate for adjustably mounting the miniature camera to the wand.

8. The remote visual photography and observation apparatus of claim 7 further comprising a locking bolt that is insertable through the aligned pairs of through holes of the plates and the aperture of the pivot portion for pivotably interconnecting the miniature camera to the upper end of the wand.
